(19) United States
(12) Patent Application Publication
(10) Pub. No.: US 2025/0110893 A1
(43) Pub. Date: Apr. 3, 2025

(54) CACHE VIRTUALIZATION

(71) Applicants: Advanced Micro Devices, Inc., Santa Clara, CA (US); ATI Technologies ULC, Markham (CA)

(72) Inventors: John Szeto, Santa Clara, CA (US); Anthony Asaro, Markham (CA); Kostantinos Danny Christidis, Toronto (CA); Wade K. Smith, Sunnyvale, CA (US)

(21) Appl. No.: 18/478,757

(22) Filed: Sep. 29, 2023

(51) Int. Cl. G06F 12/1027; G06F 12/0873

(52) U.S. Cl. CPC G06F 12/1027; G06F 12/0873

(57) ABSTRACT

An apparatus and method for efficiently performing address translation requests. An integrated circuit includes a system memory that stores address mappings, and the circuitry of one or more clients processes one or more applications and generate address translation requests. A translation lookaside buffer (TLB) stores, in multiple entries, address mappings retrieved from the system memory. Circuitry of a client processes one or more applications and generates address translation requests. The entries of the TLB stores address mappings corresponding to different address mapping types and different virtual functions to avoid searches of multiple other lower-level TLBs that are significantly larger and have larger access. In addition, the TLB is implemented with a relatively small number of entries and uses fully associative data storage arrangement to further reduce access latencies.

### BACKGROUND

### Description of the Relevant Art

A variety of computing devices and systems utilize heterogeneous integration in which multiple types of clients are integrated to provide system functionality. Each includes circuitry for generating memory access requests and processing data to provide one of a variety of functions. Examples of the variety of functions are audio/video (A/V) data processing, other high parallel data applications for the medicine and business fields, processing instructions of a general-purpose instruction set architecture (ISA), digital, analog, mixed-signal and radio-frequency (RF) functions, and so forth. Several types of data-intensive applications executed by the clients rely on quick access to data storage to provide reliable high-performance for local and remote programs and their users. The memory hierarchy transitions from relatively fast, volatile memory, such as registers on a processor die and caches either located on the processor die or connected to the processor die, to non-volatile and relatively slow memory. The interfaces and access mechanisms for the different types of memory also change.

Users prefer to more easily extend their applications to use different types of clients without explicitly copying data or transforming pointer-based data structures. To allow such an extension of their applications, two or more of the multiple types of clients support generating memory accesses using virtual addresses. However, supporting virtual memory for two or more clients includes translating an initial address to a final address for these two or more clients on each memory access. The address translation overhead can reduce performance while increasing power consumption, especially when the memory accesses are sent to lower levels of the cache memory subsystem that stores the address translations.

In view of the above, efficient methods and mechanisms for efficiently performing address translation requests of an integrated circuit are desired.

### BRIEF DESCRIPTION OF THE DRAWINGS

FIG. 1 is a generalized diagram of an apparatus efficiently processes memory access requests of an integrated circuit relying on address translations.

FIG. 2 is a generalized diagram is shown of a translation lookaside buffer (TLB) that efficiently performs address translation requests of an integrated circuit.

FIG. 3 is a generalized diagram of a method that efficiently performs address translation requests of an integrated circuit.

FIG. 4 is a generalized diagram of a method that efficiently performs address translation requests of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods that efficiently perform address translation requests of an integrated circuit. In various implementations, a system memory stores address mappings, and the circuitry of one or more clients processes one or more applications and generate address translation requests. A translation lookaside buffer (TLB) stores, in multiple entries, address mappings retrieved from the system memory. Examples of the variety of functions provided by executing, the one or more applications, by the one or more clients, are audio/video (A/V) data processing, other high parallel data applications for the medicine and business fields, processing instructions of a general-purpose instruction set architecture (ISA), digital, analog, mixed-signal and radio-frequency (RF) functions, and so forth. Each of the one or more clients includes data processing circuitry, and in some implementations, one or more clients also includes a local memory. Examples of the one or more clients are a general-purpose central processing unit (CPU), a single processor core of the CPU, a real-time multimedia circuit, a display controller, a video input circuit connected to a camera, one of a variety of types of an application specific integrated circuit (ASIC), a digital signal processor (DSP), a field programmable gate array (FPGA), a parallel data processor with a relatively wide single-instruction-multiple-data (SIMD) microarchitecture such as a graphics processing unit (GPU), one or more compute circuits of multiple compute circuits of a GPU, and so forth.

Circuitry of the TLB receives, from the client, an address translation request that includes an initial address. The circuitry of the TLB retrieves, from a particular entry of its multiple entries, a final address of an address mapping between the first initial address and the first final address stored in the particular entry corresponding to a first address mapping type. In an implementation, the first address mapping type is an address mapping between a virtual address and a physical address pointing to a data storage location in a local memory of the client. Another entry of the TLB stores an address mapping corresponding to a second address mapping type different from the first address mapping type. In an implementation, the second address mapping type is an address mapping between a virtual address and a physical address pointing to a data storage location in system memory. Therefore, each of the entries of the TLB is able to store an address mapping corresponding to an address mapping type different from an address mapping type of another address mapping stored in at least one other entry of the TLB.

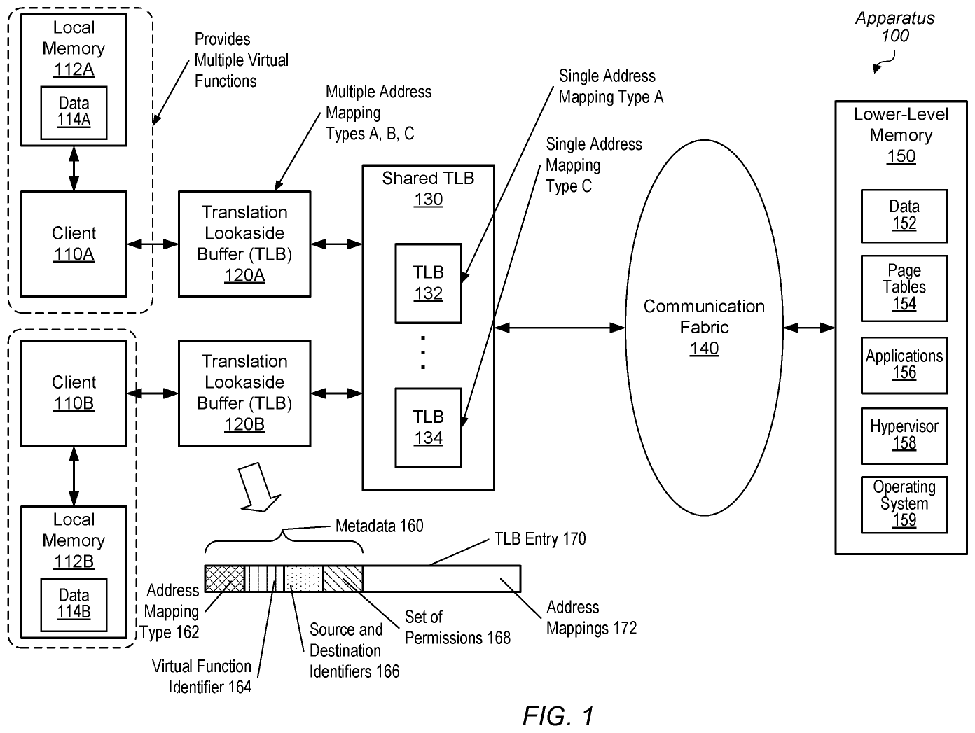

The TLB sends the final address retrieved from the particular entry of the TLB to the client. In various implementations, the TLB is implemented with a relatively small number of entries and uses fully associative data storage arrangement, rather than a set-associative data storage arrangement. Therefore, the TLB is able to operate quickly to provide address translations to the client. When computing resources of the client are shared by multiple virtual machines, each of the entries of the TLB is also able to store an address mapping corresponding to virtual function different from a virtual function of another address mapping stored in at least one other entry of the TLB. In an implementation, a third address mapping type stored in the TLB is an address mapping between a guest physical address and a physical address pointing to a data storage location in system memory. By having the entries of this TLB store address mappings corresponding to different address mapping types and different virtual functions, searches of multiple other lower-level TLBs that are significantly larger and have larger access latencies are avoided. Further details of these techniques that efficiently perform address translation requests of an integrated circuit are provided in the following description of FIGS. 1-4.

Referring now to FIG. 1, a generalized diagram is shown of an apparatus 100 that efficiently processes memory access requests of an integrated circuit relying on address translations. In an implementation, apparatus 100 includes at least clients 110A-110B, translation lookaside buffers (TLBs) 120A-120B, shared TLB 130, communication fabric 140, and lower-level memory 150. In other implementations, apparatus 100 includes other components and/or apparatus 100 is arranged differently. For example, power managers, a network interface, a display controller, other types of input/output (I/O) peripheral devices and corresponding interfaces, phased locked loops (PLLs) or other clock generating circuitry, and so forth are not shown for ease of illustration. In various implementations, the components of the apparatus 100 are on a same die such as a system-on-a-chip (SOC). In other implementations, the components are individual dies in a system-in-package (SiP) or a multi-chip module (MCM). A variety of computing devices use the apparatus 100 such as a desktop computer, a laptop computer, a server computer, a tablet computer, a smartphone, a gaming device, a smartwatch, and so on.

As used herein, a “client” refers to an integrated circuit with data processing circuitry and internal memory, which has tasks assigned to it by a scheduler such as an operating system (OS) scheduler or other. Examples of tasks are software threads of a process of an application, which are scheduled by the OS scheduler. Examples of the clients 110A-110B are a general-purpose central processing unit (CPU), a single processor core of the CPU, a real-time multimedia circuit, a display controller, a video input circuit connected to a camera, one of a variety of types of an application specific integrated circuit (ASIC), a digital signal processor (DSP), a field programmable gate array (FPGA), a parallel data processor with a relatively wide single-instruction-multiple-data (SIMD) microarchitecture such as a graphics processing unit (GPU), one or more compute circuits of multiple compute circuits of a GPU, and so forth. The circuitry of the clients 110A-110B processes one or more applications. Examples of the variety of functions provided by the execution of the one or more applications are audio/video (A/V) data processing, other highly parallel data applications for the medicine and business fields, processing instructions of a general-purpose instruction set architecture (ISA), digital, analog, mixed-signal and radio-frequency (RF) functions, and so forth.

The lower-level memory 150 is representative of one or more of a variety of types of dynamic random-access memories (DRAMs) used to implement a system memory and one of a variety of types of disk data storage, such as a hard disk drive (HDD), a solid-state disk (SSD) drive, and so forth, used to implement a main memory. The lower-level memory 150 includes one or memory interfaces to communicate with particular memory devices used for data storage. Although a single level is shown for the lower-level memory 150, in various implementations, the lower-level memory 150 includes multiple levels of memory hierarchy such as a system memory followed by a main memory. The lower-level memory 150 stores a copy of at least one operating system 159. The lower-level memory 150 also stores data 152 that can be source data, intermediate results data, and final results data for the applications 156. The lower-level memory 150 also stores a copy of a page table 154.

Each of the page tables 154 stores address mappings of initial addresses to final addresses. In some implementations, the initial addresses are virtual addresses (linear addresses) and the final addresses are physical addresses where virtual pages are loaded in the physical memory. In some implementations, these physical addresses point to physical data storage locations in the lower-level memory 150 such as a system memory. A virtual address space for the data stored in the lower-level memory 150 and used by a software process executed by one of the clients 110A-110B is typically divided into pages of a prefixed size. Examples of the pages sizes are 4 kilobytes (KB), 64 KB, 256 KB, 1 gigabyte (GB), 8 terabytes (TB), and so forth. The virtual pages are mapped to frames of physical memory. The mappings of virtual addresses to physical addresses where virtual pages are loaded in the physical memory are stored in one of the page tables 154.

In an implementation, the client 110A is a GPU and a ring buffer storing commands translated by a CPU for the GPU is located in the system memory such as the lower-level memory 150. To access the ring buffer, the GPU requires a virtual address to be translated to a physical address pointing to a physical memory location in the system memory of the computing system. This address mapping between the virtual address of the GPU (client 110A) and the physical address of the system memory (lower-level memory 150) is an example of an address mapping type “A.”

It is also possible that one or more of the page tables 154 store address mappings between initial addresses and final addresses where, again, the initial addresses are virtual addresses (linear addresses). However, the final addresses are physical addresses that point to physical data storage locations in one of the local memories 112A-112B, rather than point to physical data storage locations in the lower-level memory 150. In an implementation, the client 110A is a discrete GPU, rather than a GPU integrated with a CPU in a same package, and the local memory 112A is one of a variety of types of synchronous random-access memory (SRAM) in a separate semiconductor package on the motherboard. The local memory 112A stores the data 114A that includes source data, intermediate results data, and final results data. In an implementation, the client 110A is a GPU, the local memory 112A is a dedicated local video memory, and the data 114A is video graphics data. Similarly, the local memory 112B stores the data 114B for the client 110B.

In various implementations, each of the local memory 112A and the local memory 112B has higher data rates, higher data bandwidth, and higher power consumption than the lower-level memory 150. In an implementation, the client 110A includes a memory controller (not shown) that transfers data with the local memory 112A using one or more memory access communication channels and communicates with the local memory 112A using a point-to-point communication protocol such as one of the versions of the Graphics Double Data Rate (GDDR) protocol. In an implementation, the lower-level memory 150 transfers data with the communication fabric 140 using a communication channel that supports a communication protocol such as the Peripheral Component Interconnect Express (PCIe) protocol. This address mapping between the virtual address of the GPU (client 110A) and the physical address of the local memory (local memory 112A or 112B) is an example of an address mapping type “B.” An example of a third address mapping type “C” that utilizes guest physical addresses of virtual machines is also possible and contemplated. Before further describing the third address mapping type “C,” a further description of the hierarchical cache memory subsystem that stores address mappings is provided.

To reduce the latencies of the clients 110A-110B accessing the address translation mappings stored in the page tables 154 of the lower-level memory 150, a hierarchical cache memory subsystem is used to provide access to these address translation mappings. In various implementations, each of the translation lookaside buffers (TLBs) 120A, 120B and 130 stores a subset of address translation mappings of one or more of the page tables 154. As shown, in an implementation, each of the clients 110A-110B has its own dedicated TLB such as the TLB 120A for the client 110A. Similarly, the client 110B accesses the TLB 120B, which the client 110A does not access. Each of the clients 110A-110B accesses the shared TLB 130 when a requested address mapping is not found in a respective one of the TLBs 120A-120B. In some implementations, the shared TLB 130 includes multiple TLBs such as TLBs 132 and 134. Although the shared TLB 130 is shown to include two TLBs 132 and 134, in other implementations, the shared TLB 130 includes another number of TLBs based on design requirements.

In various implementations, each of the TLBs 120A-120B includes TLB entries where each TLB entry 170 is capable of storing one of multiple address mapping types such as the address mapping types “A,” “B,” and “C.” In contrast, each of the TLBs 132 and 134 of the shared TLB 130 includes TLB entries capable of storing a single address mapping type. In some implementations, the TLB 132 includes TLB entries capable of storing the single address mapping type “A,” and the TLB 134 includes TLB entries capable of storing only one of the single address mapping types “B” and “C.” It is noted that although three address mapping types “A,” “B,” and “C” are shown, in other implementations, the apparatus 100 supports another number of address mapping types based on design requirements.

As shown, each of the TLBs 120A-120B includes TLB entries where each TLB entry is capable of storing information of the TLB entry 170. The TLB entry 170 stores address mappings 172 that maps an initial address to a final address. The TLB entry 170 also stores metadata 160 that includes at least the multiple fields 162-168. The field 162 stores an indication of an address mapping type. For example, the field 162 stores an indication specifying one of multiple address mapping types such as at least the three address mapping types “A,” “B,” and “C.” Therefore, it is possible and contemplated that each of the TLB entries of the TLBs 120A-120B stores information corresponding to a different address mapping type of a neighboring TLB entry.

The field 164 stores an indication of a virtual function identifier. As further described shortly, a virtual machine (VM) supported by the hypervisor 158 has one or more virtual functions (VFs) mapped to it. A shared input/output (I/O) device (not shown for ease of illustration) provides a single physical function (PF), but when the circuitry of a client of the clients 110A-110B executes the hypervisor 158, the circuitry of this client expands the single physical function to multiple virtual functions. Each of the multiple virtual functions is mapped to a single, respective virtual machine of multiple virtual machines generated by the hypervisor 158. Therefore, it is possible and contemplated that each of the TLB entries of the TLBs 120A-120B stores information corresponding to a different virtual function of a neighboring TLB entry.

The field 166 stores source identifier information and destination identifier information. The source identifier information can include an identifier (ID) of a processor core, a compute circuit, or other of the clients 110A-110B that generated a corresponding memory access request and resulting address translation request. The source identifier information can include a process ID, an application ID, a virtual machine ID, and so forth. The destination information of the field 166 can include an identifier of one of the local memory 112A, the local memory 112B, and one of the memories used to implement the lower-level memory 150. The field 168 stores a set of data access permissions corresponding to the address mappings 172. Examples of the data access permissions are no access permission, read only permission, write only permission, read and write permission, and read and execute permission.

Although not shown, the TLB entry 170 also stores status information such as at least a valid bit. The status information can also include cache eviction information such as an indication used by a Least Recently Used (LRU) algorithm that determines which TLB entry to have its data evicted and replaced by cache fill line data being allocated. As used herein, the term “allocate” refers to storing a cache fill line fetched from a lower level of the cache hierarchy into a way or an entry of a particular cache subsequent a cache miss to the particular cache. The status information can also include an indication of a state of a cache coherency protocol such as the MOESI protocol with the Modified (M), Owned (O), Exclusive (E), Shared(S), and Invalid (I) states. Other examples of status information are possible and contemplated.

In some implementations, one or more of the TLBs 120A-120B is implemented as a fully associative cache. In an implementation, one or more of the TLBs 120A-120B includes a relatively small number of entries such as 32 entries. The small size and the fully associative data storage arrangement allows one or more of the TLBs 120A-120B to operate quickly to provide address translations to a corresponding one of the clients 110A-110B. In other implementations, one or more of the TLBs 120A-120B uses another number of entries based on design requirements. Additionally, in other implementations, one or more of the TLBs 120A-120B uses a set-associative data storage arrangement or a direct mapped data storage arrangement based on design requirements.

In contrast to the TLBs 120A-120B, the TLB entries of each of the TLBs 132 and 134 of the shared TLB 130 do not include the address mapping type field 162 and the virtual function identifier field 164, since the TLB entries of the TLBs 132 and 134 store information corresponding to a single address mapping type and a single virtual function. The TLBs 132 and 134 have a much larger number of TLB entries than the TLBs 120A-120B, and the TLBs 132 and 134 typically use a set-associate data storage arrangement. The access latencies of the TLBs 132 and 134 are larger than the access latencies of the TLBs 120A-120B.

As described earlier, in some implementations, the initial addresses are guest physical addresses pointing to physical memory locations in a system memory of the lower-level memory 150. The guest physical addresses belong to a physical memory region assigned by one of the clients 110A-110B executing the hypervisor 158 to a guest operating system in a virtualized computing system. The final addresses are physical addresses pointing to physical memory locations in the system memory. For example, to simplify software development and testing, in some implementations, the apparatus 100 supports virtualization that includes a software layer, or virtualization layer, added between the hardware of the circuits of the apparatus 100 and the operating system 159. When executed by circuitry of one or more of the clients 110A-110B, this software layer runs on top of the host operating system 159, and this software layer spawns higher-level virtual machines (VMs).

Each virtual machine includes its own copy of a guest operating system, its own copies of one or more device drivers, and its own copies of applications 156. This software layer monitors the multiple virtual machines and redirects requests for resources, such as circuitry of the apparatus 100, to appropriate application program interfaces (APIs) in the hosting environment. This software layer is referred to as a hypervisor or a virtual machine monitor (VMM). The lower-level memory 150 stores a copy of the hypervisor 158.

When the circuitry of a client of the clients 110A-110B executes the hypervisor 158, the circuitry of this client presents an appearance to copies of the applications 156 within a particular virtual machine that each of these applications 156 has unrestricted access to a set of computing resources of this client. When the circuitry of a client of the clients 110A-110B executes the hypervisor 158, the circuitry of this client supports time-sharing of the circuitry of this client between multiple guest operating systems of multiple virtual machines running on the circuitry of this client. In other implementations, the circuitry of a CPU executes the hypervisor 158 and the circuitry of the clients 110A-110B are treated as computing resources to be time-shared across multiple virtual machines. In an implementation, each of the clients 110A-110B is a separate, discrete GPU. In other implementations, each of the clients 110A-110B is a set of compute circuits within a same GPU where each compute circuit includes multiple lanes of execution that operate in a lockstep manner and use a highly parallel data microarchitecture. In yet other implementations, each of the clients 110A-110B includes circuitry of another type of computing resource being time-shared across multiple virtual machines.

In addition to a virtual machine having its own copy of a guest operating system, its own copies of one or more device drivers, and its own copies of applications 156, the virtual machine supported by the hypervisor 158 also has one or more virtual functions (VFs) mapped to it. A shared input/output (I/O) device provides a single physical function (PF), but when the circuitry of a client of the clients 110A-110B executes the hypervisor 158, the circuitry of this client expands the single physical function to multiple virtual functions. Each of the multiple virtual functions is mapped to a single, respective virtual machine of multiple virtual machines generated by the hypervisor 158. To each of the multiple virtual machines, a virtual device driver of a respective virtual function behaves as if the virtual function is a dedicated physical function provided by a physical function driver.

In an implementation, an I/O device (not shown) is connected to the client 110A, and this I/O device uses a communication channel that supports a communication protocol such as the Peripheral Component Interconnect Express (PCIe) protocol. This I/O device has a single physical function supported by a single physical function device driver. When the circuitry of client 110A executes the hypervisor 158, the circuitry of client 110A supports 16 virtual machines with each of these 16 virtual machines having a single, respective virtual function supported by a single, respective virtual function device driver. The circuitry of the client 110A supports 16 virtual functions, each with its own virtual function device driver within a respective one of the 16 virtual machines. Therefore, as described earlier, one or more of the page tables 154 stores mappings between initial addresses and final addresses where the initial addresses are guest physical addresses pointing to physical memory locations in a system memory of the lower-level memory 150. The final addresses are physical addresses (non-guest physical addresses) pointing to physical memory locations in the system memory of the lower-level memory 150.

In an implementation, when the circuitry of the client 110A executes the hypervisor 158, the circuitry of the client 110A generates and supports a virtual machine “A” that has a guest operating system “A” and executes its copy of an application “D” of the applications 156. The circuitry of the client 110A also generates and supports a virtual machine “B” that has a guest operating system “B” and executes its copy of the application “D” of the applications 156. The virtual machine “A” maps a guest virtual address 0x00d8 used by its copy of the application “D” to a guest physical address 0x1000 where the prefix “0x” indicates a hexadecimal value. Therefore, each hexadecimal digit actually includes four binary digits (bits). The virtual machine “B” maps a guest virtual address 0x0080 used by its copy of the application “D” to a guest physical address 0x1000. To differentiate the guest physical addresses belonging to two different virtual machines (“A” and “B”) that have a same guest physical address (0x1000), the circuitry of the client 110A performs host layer address translations when executing the hypervisor 158. To do so, when executing the hypervisor 158, the circuitry of the client 110A maps the guest physical address of 0x1000 of the virtual machine “A” to a system memory physical address of 0x7400. When executing the hypervisor 158, the circuitry of the client 110A maps the guest physical address of 0x1000 of the virtual machine “B” to a system memory physical address of 0xb100.

The virtual machine “A” performs a first address translation operation to translate the guest virtual address 0x00d8 to the guest physical address 0x1000. When executing the hypervisor 158, the circuitry of the client 110A performs a host address translation operation to translate the guest physical address 0x1000 to the system memory physical address 0x7400. This mapping (0x1000 to 0x7400) of the host address translation operation can be stored in a page table of the page tables 154. Additionally, this mapping can be stored in one of the TLB entry 170 of the TLB 120A. Similarly, the virtual machine “B” performs a first address translation operation to translate the guest virtual address 0x0080 to the guest physical address 0x1000. When executing the hypervisor 158, the circuitry of the client 110A performs a host address translation operation to translate the guest physical address 0x1000 to the system memory physical address 0xb100. This mapping (0x1000 to 0xb100) of the host address translation operation can be stored in the same page table of the page tables 154. Additionally, this mapping can be stored in one of the TLB entry 170 of the TLB 120A. To differentiate the two mappings, a virtual function identifier (VF ID) is stored in the metadata of the TLB entry 170 and the page table entries (PTEs) of this page table of the page tables 154.

As described earlier, the TLBs 120A-120B include TLB entries, such as the TLB entry 170, capable of storing address mappings 172 corresponding to different address mapping types (as indicated by the field 162) and corresponding to different virtual functions (as indicated by the field 164). When a particular address mapping is missing in the TLB 120A, the address translation request is sent to the shared TLB 130. The particular TLB of the TLBs 132-134 selected for a search by control circuitry of the shared TLB 130 is based on one or more of the address mapping type and the virtual function of the address translation request. In some implementations, an address translation requires a search of at least two TLBs of the TLBs 132-134.

In an implementation, an address translation request uses an address mapping between an initial address and a final address of the address mapping types “A” and “C.” This address translation request includes an initial address that is a guest virtual address such as the address 0x00d8 used in the earlier example for the virtual machine “A.” This address translation request includes a final address that is a physical address (non-guest physical address) pointing to physical memory locations in the system memory of the lower-level memory 150. An example of this physical address is the system memory physical address 0x7400 used in the earlier example for the virtual machine “A.” This address translation includes two separate address translations as described earlier, and thus, uses two separate sequential searches of two separate TLBs of the shared TLB 130. The latency of these separate searches, especially when a page walk is also required due to a miss in either of the two separate TLBs 132 and 134, is significant. Once the address translation is complete, though, this address translation can be stored in an allocated TLB entry of the TLB 120A, which reduces the address translation latency for subsequent address translation requests.

Communication fabric 140 (or the fabric 140) transfers data back and forth between the lower-level memory 150 and the clients 110A-110B, the TLBs 120A-120B and 130, and a variety of other components such as input/output (I/O) interfaces, other clients, a power manager, a network interface, and so forth. These other components are not shown for ease of illustration. The fabric 140 includes interfaces for supporting respective communication protocols. The protocols determine values used for information transfer, such as a number of data transfers per clock cycle, signal voltage levels, signal timings, signal and clock phases and clock frequencies. Examples of the data transferred across the communication fabric 140 are commands, messages, probes, interrupts, response commands, response data, and payload data corresponding to the commands and messages. The fabric 140 includes queues for storing requests and responses. The fabric 140 also includes selection circuitry for arbitrating between received requests or received responses before sending requests (or responses) across an internal network between intermediate queues. Additional circuitry in the fabric 140 builds and decodes packets as well as selects routes for the packets. Fabric 140 uses one or more of point-to-point connections, buses and multi-port routers to transfer information.

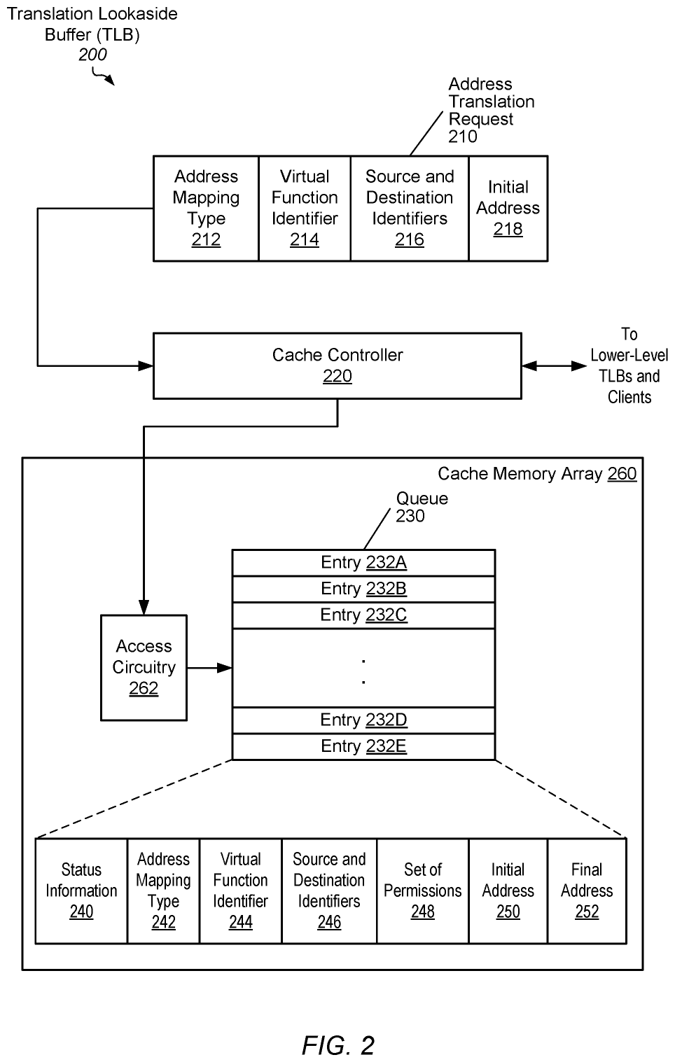

Turning now to FIG. 2, a generalized diagram is shown of a translation lookaside buffer (TLB) 200 that efficiently performs address translation requests of an integrated circuit. In various implementations, the TLB 200 includes a cache controller 220 and a cache memory array 260 with a queue 230 that has multiple queue entries 232A-232E (or TLB entries 232A-232E, or entries 232A-232E). The cache controller 220 receives an address translation request 210 from a corresponding client, and sends the address translation request 210 to the access circuitry 262 to search the queue 230 for a requested address translation (or address mapping).

The queue 230 is implemented as one of a set of registers, a set of flip-flop circuits, a table, a content addressable memory (CAM), a register file, one of a variety of types of a random-access memory (RAM), and so forth. In some implementations, the circuitry of the cache controller 220 allocates and deallocates (invalidates) entries of the entries 232A-232E in a fully associative manner. In other words, no set-associativity is used by the cache controller 220. In an implementation, the queue 230 includes a relatively small number of entries 232A-232E such as 32 entries. The small size and the fully associative data storage arrangement of the queue 230 allows the TLB 200 to operate quickly to provide address translations to a corresponding client.

The address translation request 210 includes multiple fields 212-218. In some implementations, the fields 212, 214 and 216 store information described earlier as being stored in the fields 162, 164 and 166 of the TLB entry 170 (of FIG. 1). For example, the field 212 stores an address mapping type, the field 214 stores a virtual function identifier, and the field 216 stores source identifier information and destination identifier information. The field 218 stores the initial address that is to be translated to a final address. The access circuitry 262 receives the address translation request 210, and searches the queue 230 based on the information stored in the fields 212-218.

Each of the entries 232A-232E includes the fields 240-252. In some implementations, the field 240 stores status information as described earlier for the TLB entry 170 (of FIG. 1), the fields 242, 244, 246 and 248 store information described earlier as being stored in the fields 162, 164, 166 and 168 of the TLB entry 170 (of FIG. 1). The fields 250 and 252 store the address mapping between an initial address and a final address. Each of the initial address and the final address has one of multiple address types such as a virtual address, guest physical address, a non-guest physical address pointing to a physical storage location in a local memory of the client, and a non-guest physical address pointing to a physical storage location in system memory. The address type is based on the information stored in the fields 242, 244 and 246.

The access circuitry 262 compares the information stored in the fields 212-218 of the address translation request 210 to the information stored in the fields 242-246 and 250 of valid (allocated) entries of the entries 232A-232E as indicated by the status information in the fields 240. When a match is found (a hit occurs), the cache controller 220 sends, to a requesting client, information from the fields 248 and 252 of the matching entry. The cache controller 220 also updates any LRU or other eviction information stored in the status information of the field 240 of the matching entry. Again, in some implementations, due to the small size and the fully associative data storage arrangement of the queue 230, the TLB 200 is able to operate quickly to provide address translations to a corresponding client. When no match is found (a miss occurs), the cache controller 220 sends the address translation request 210 to lower-level TLBs, and later allocates one of the entries 232A-232E with fill information. Additionally, the cache controller 220 sends information from the fields 248 and 252 of the fill information to the requesting client.

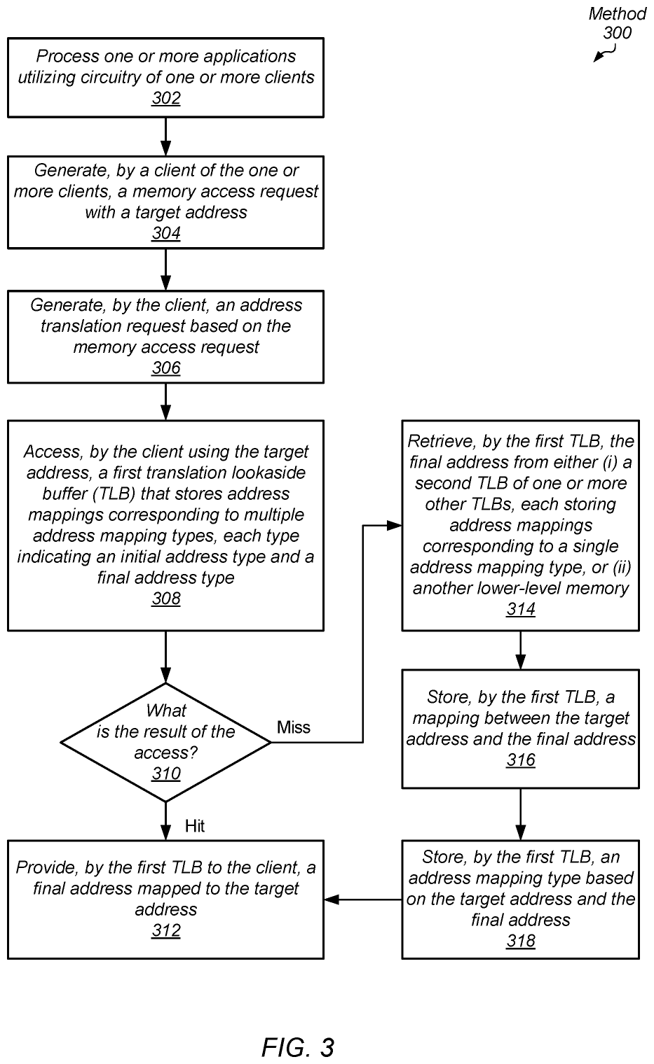

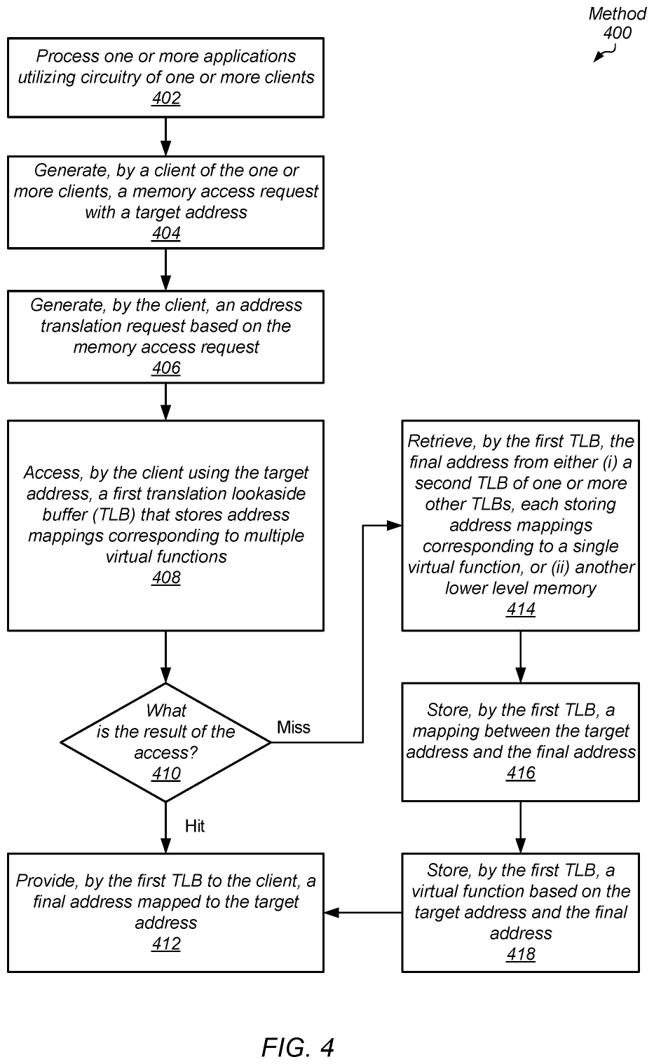

Referring to FIG. 3, a generalized diagram is shown of a method 300 that efficiently performs address translation requests of an integrated circuit. For purposes of discussion, the steps in this implementation (as well as in FIG. 4) are shown in sequential order. However, in other implementations some steps occur in a different order than shown, some steps are performed concurrently, some steps are combined with other steps, and some steps are absent.

The circuitry of one or more clients processes one or more applications (block 302). Examples of the variety of functions provided by the execution of the one or more applications are audio/video (A/V) data processing, other high parallel data applications for the medicine and business fields, processing instructions of a general-purpose instruction set architecture (ISA), digital, analog, mixed-signal and radio-frequency (RF) functions, and so forth. Each of the one or more clients includes data processing circuitry, and in some implementations, one or more clients also includes a local memory. Examples of the one or more clients are a general-purpose central processing unit (CPU), a single processor core of the CPU, a real-time multimedia circuit, a display controller, a video input circuit connected to a camera, one of a variety of types of an application specific integrated circuit (ASIC), a digital signal processor (DSP), a field programmable gate array (FPGA), a parallel data processor with a relatively wide single-instruction-multiple-data (SIMD) microarchitecture such as a graphics processing unit (GPU), one or more compute circuits of multiple compute circuits of a GPU, and so forth.

A client of the one or more clients generates a memory access request with a target address (block 304). The client generates an address translation request based on the memory access request (block 306). The client, using the target address, accesses a first translation lookaside buffer (TLB) that stores address mappings corresponding to multiple address mapping types with each address mapping type indicating a separate pair of an initial address type and a final address type (block 308). In some implementations, a first address mapping type includes a pair of address types such as an initial address type is a virtual address (linear address) of a virtual memory region assigned to the client. The pair of address types of the first address mapping type also includes the final address type as a physical address pointing to a physical memory location in a local memory of the client. In an implementation, the client is a discrete GPU and the local memory is one of a variety of types of DRAM used as video memory or used for storing other types of source data and results data for medicine, business, scientific or other applications.

A second address mapping type different from the first address mapping type includes a pair of address types such as an initial address type as a virtual address (linear address) of a virtual memory region assigned to the client. The pair of address types of the second address mapping type also includes the final address type as a physical address pointing to a physical memory location in a system memory of the computing system. In an implementation, the client is a GPU and a ring buffer storing commands translated by a CPU for the GPU is located in the system memory. To access the ring buffer, the GPU requires a virtual address to be translated to a physical address pointing to a physical memory location in the system memory of the computing system. The first TLB can store such an address mapping belonging to this second address mapping type different from the first address mapping type.

If the result of the access of the first TLB is a hit (“Hit” branch of the conditional block 310), then the first TLB provides, to the client, a final address mapped to the target address of the address translation request (block 312). In various implementations, the address translation request from the client includes an indication specifying a particular address mapping type of multiple address mapping types. For example, the address translation request from the client includes an indication specifying one of the above first address mapping type and the second address mapping type. The control circuitry of the first TLB uses at least this indication along with the target address to determine whether a corresponding cache memory array stores an address mapping for the address translation request from the client. Although two address mapping types are described here, in other implementations, the first TLB stores address mappings corresponding to any number of address mapping types based on design requirement.

In some implementations, the first TLB is implemented as a fully associative cache. In an implementation, the first TLB includes a relatively small number of entries such as 32 entries. The small size and the fully associative data storage arrangement allows the first TLB to operate quickly to provide address translations to the client. In other implementations, the first TLB uses another number of entries based on design requirements. Additionally, in other implementations, the first TLB uses a set-associative data storage arrangement or a direct mapped data storage arrangement based on design requirements.

If the result of the access of the first TLB is a miss (“Miss” branch of the conditional block 310), then in block 314 of method 300, the first TLB retrieves the final address from either (i) a second TLB of one or more other lower-level TLBs, each storing address mappings corresponding to a single address mapping type, or (ii) another lower-level memory. Examples of the lower-level memory are system memory implemented by one of a variety of types of DRAM, and main memory implemented by one of a variety of types of a disk data storage such as a hard disk driver (HDD), a solid-state disk (SSD) drive, and so forth. The one or more other TLBs form with the first TLB a hierarchical address translation cache memory subsystem. However, in contrast to the first TLB, these one or more other TLBs do not store address translations corresponding to multiple address mapping types. Rather, these one or more other TLBs store address translations corresponding to a single address mapping type.

In an implementation, one of these other TLBs store address translations corresponding to only a single address mapping type that includes an initial address type that is a virtual address (linear address) of a virtual memory region assigned to the client and a final address type that is a physical address pointing to a physical memory location in a local memory of the client. Another TLB of these other TLBs store address translations corresponding to only a single address mapping type that includes an initial address type that is a virtual address (linear address) of a virtual memory region assigned to the client and a final address type that is a physical address pointing to a physical memory location in a system memory of the computing system. The first TLB stores an address mapping between the target address (initial address) of the address translation request and the retrieved final address (block 316). For example, the access circuitry allocates an entry in the first TLB for this address mapping. The first TLB stores an address mapping type based on the type of the target address and the type of the final address in the allocated entry (block 318). Afterward, the control flow of method 300 moves to block 312 where the first TLB provides, to the client, the final address mapped to the target address of the address translation request.

Turning now to FIG. 4, a generalized diagram is shown of a method 400 that efficiently performs address translation requests of an integrated circuit. The circuitry of one or more clients processes one or more applications (block 402). Examples of the variety of functions provided by the execution of the one or more applications and examples of clients were provided earlier. A client of the one or more clients generates a memory access request with a target address (block 404). The client generates an address translation request based on the memory access request (block 406). The client, using the target address, accesses a first translation lookaside buffer (TLB) that stores address mappings corresponding to multiple virtual functions (block 408). In various implementations, when the circuitry of a processor executes the instructions of a hypervisor, the processor supports multiple virtual machines. The received address translation request includes a field identifying an address mapping type and a field identifying a virtual function. In various implementations, these fields store the same information as stored in fields 162 and 164 (of FIG. 1) and fields 212 and 214 (of FIG. 2)

In some implementations, a particular address mapping type includes the initial address type as a guest physical address type. A guest physical address points to a physical memory location in a system memory of the computing system. However, this physical address belongs to a physical memory region assigned by a hypervisor to a guest operating system in a virtualized computing system. This address mapping type also includes the final address type as a physical address type. The physical address points to a physical memory location in the system memory of the computing system. In another implementation, the address mapping type includes the same final address type, but the initial address type is a guest virtual address.

For either of the two above address mapping types, it is possible that the guest physical address has a same address value as another guest physical address that belongs to another physical memory region assigned by the hypervisor to another guest operating system in the virtualized computing system. As described earlier, an example of this situation includes the hypervisor supporting both a virtual machine “A” that has a guest operating system “A” and a virtual machine “B” that has a guest operating system “B.” Both of these virtual machines “A” and “B” use a same guest physical address 0x1000 when executing a respective copy of the application “D.”

To differentiate between these two guest physical addresses, when circuitry of a processor executes the instructions of the hypervisor, the processor performs host layer address translations to generate separate physical addresses for the virtual machines “A” and “B.” In the earlier example, when performing the host layer address translations by executing the hypervisor, the processor generates an address mapping between the guest physical address 0x1000 and the system memory physical address of 0x7400 for the virtual machine “A,” and the processor generates an address mapping between the guest physical address 0x1000 and the system memory physical address of 0xb100 for the virtual machine “B.” Once generated, these address mappings can be stored in the first TLB for more efficient address translations of subsequent address translation requests. In some implementations, the first TLB is implemented as a fully associative cache with a relatively small number of entries to support quick address translations.

In various implementations, the access circuitry of the first TLB uses the address mapping type and the virtual function identified in the address translation request along with an initial address when searching the first TLB. If the result of the access of the first TLB is a hit (“Hit” branch of the conditional block 410), then the first TLB provides, to the client, a final address mapped to the target address of the address translation request (block 412). If the result of the access of the first TLB is a miss (“Miss” branch of the conditional block 410), then in block 414 of method 400, the first TLB retrieves the final address from either (i) a second TLB of one or more other lower-level TLBs, each storing address mappings corresponding to a single address mapping type, or (ii) another lower-level memory. Examples of the lower-level memory are system memory implemented by one of a variety of types of DRAM, and main memory implemented by one of a variety of types of a disk data storage such as a hard disk driver (HDD), a solid-state disk (SSD) drive, and so forth.

The one or more other TLBs form with the first TLB a hierarchical address translation cache memory subsystem. However, in contrast to the first TLB, these one or more other TLBs do not store address translations corresponding to multiple virtual functions. Rather, these one or more other TLBs store address translations corresponding to a single virtual function. After retrieving the final address, the first TLB stores an address mapping between the target address (initial address) of the address translation request and the retrieved final address (block 416). For example, the access circuitry allocates an entry in the first TLB for this address mapping. The first TLB stores an identifier of the virtual function in the allocated entry (block 418). Afterward, the control flow of method 400 moves to block 412 where the first TLB provides, to the client, the final address mapped to the target address of the address translation request.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An integrated circuit comprising:
a translation lookaside buffer (TLB) comprising circuitry configured to:
receive, from a client, a first address translation request comprising a first initial address;
retrieve, from a first entry of a plurality of entries of the TLB, a first final address of an address mapped to the first initial address, wherein the first entry corresponds to a first address mapping type and a second entry of the plurality of entries stores an address mapping corresponds to a second address mapping type different from the first address mapping type; and
send the first final address to the client.

2. The integrated circuit as recited in claim 1, wherein the first address mapping type is an address mapping between a virtual address and a physical address of a data storage location in a local memory coupled to the client.

3. The integrated circuit as recited in claim 1, wherein the second address mapping type is an address mapping between a virtual address and a physical address of a data storage location in system memory.

4. The integrated circuit as recited in claim 1, wherein the plurality of entries of the TLB utilize a fully associative data storage arrangement.

5. The integrated circuit as recited in claim 1, wherein the circuitry is configured to:
receive, from the client, a second address translation request comprising a second initial address; and
retrieve, from a third entry of the plurality of entries, a second final address of an address mapped to the second initial address, wherein the second final address corresponds to a first virtual function.

6. The integrated circuit as recited in claim 5, wherein the address mapping between the second initial address and the second final address in the third entry corresponds to a third address mapping type between a virtual address and a guest physical address assigned to a virtual machine that utilizes the first virtual function.

7. The integrated circuit as recited in claim 5, wherein the address mapping between the second initial address and the second final address stored corresponds to a third address mapping type between a guest physical address and a physical address pointing to a data storage location in system memory.

8. A method comprising:
receiving, from a client by circuitry of a translation lookaside buffer (TLB), a first address translation request comprising a first initial address;
retrieving, from a first entry of a plurality of entries of the TLB, a first final address of an address mapped to the first initial address, wherein the first entry corresponds to a first address mapping type and a second entry of the plurality of entries stores an address mapping corresponds to a second address mapping type different from the first address mapping type; and
send the first final address to the client.

9. The method as recited in claim 8, wherein the first address mapping type is an address mapping between a virtual address and a physical address of a data storage location in a local memory coupled to the client.

10. The method as recited in claim 8, wherein the second address mapping type is an address mapping between a virtual address and a physical address of a data storage location in system memory.

11. The method as recited in claim 8, further comprising storing address mappings in the plurality of entries of the TLB utilizing a fully associative data storage arrangement.

12. The method as recited in claim 8, further comprising:
receiving, from the client by the circuitry of the TLB, a second address translation request comprising a second initial address; and
retrieving, from a third entry of the plurality of entries by circuitry of the TLB, a second final address of an address mapped to the second initial address, wherein the second final address stored in the third entry corresponding to a first virtual function.

13. The method as recited in claim 12, wherein the address mapping between the second initial address and the second final address in the third entry corresponds to a third address mapping type between a virtual address and a guest physical address assigned to a virtual machine that utilizes the first virtual function.

14. The method as recited in claim 12, wherein the address mapping between the second initial address and the second final address stored corresponds to a third address mapping type between a guest physical address and a physical address pointing to a data storage location in system memory.

15. A computing system comprising:
a memory configured to store address mappings;
a client comprising circuitry configured to generate address translation requests; and
a translation lookaside buffer (TLB) comprising:
a plurality of entries, each configured to store an address mapping retrieved from the memory; and
circuitry; and
wherein the circuitry of the TLB is configured to:
receive, from the client, a first address translation request comprising a first initial address;
retrieve, from a first entry of the plurality of entries, a first final address of an address mapping between the first initial address and the first final address stored in the first entry corresponding to a first address mapping type, wherein a second entry of the plurality of entries stores an address mapping corresponding to a second address mapping type different from the first address mapping type; and
send the first final address to the client.

16. The computing system as recited in claim 15, wherein the first address mapping type is an address mapping between a virtual address and a physical address pointing to a data storage location in a local memory coupled to the client.

17. The computing system as recited in claim 16, wherein the second address mapping type is an address mapping between a virtual address and a physical address pointing to a data storage location in system memory.

18. The computing system as recited in claim 15, wherein the plurality of entries of the TLB utilize a fully associative data storage arrangement.

19. The computing system as recited in claim 15, wherein the circuitry of the TLB is configured to:
receive, from the client, a second address translation request comprising a second initial address;
retrieve, from a third entry of the plurality of entries, a second final address of an address mapping between the second initial address and the second final address stored in the third entry corresponding to a first virtual function, wherein a fourth entry of the plurality of entries stores an address mapping corresponding to a second virtual function different from the first virtual function; and
send the second final address to the client.

20. The computing system as recited in claim 19, wherein the address mapping between the second initial address and the second final address stored in the third entry has a third address mapping type between a virtual address and a guest physical address assigned to a virtual machine that utilizes the first virtual function.
